(19) United States
(12) Patent Application Publication
(10) Pub. No.: US 2009/0307726 A1
(43) Pub. Date: Dec. 10, 2009

(54) Systems and methods for recommending age-range appropriate episodes of program content

(76) Inventors: Andrew Christopher Levin, San Francisco, CA (US); Alvin Peter Lee, Oakland, CA (US); Melinda Jane Sacks, Palo Alto, CA (US); Dennis Tenenboym, San Francisco, CA (US)

Correspondence Address: MICROSOFT CORPORATION, ONE MICROSOFT WAY, REDMOND, WA, 98052, US

(21) Appl. No.: 10/180,954

(22) Filed: Jun. 26, 2002

(51) Int. Cl. H04N 5/445

(52) U.S. Cl. 725/46

(57) ABSTRACT

Electronic program guide (EPG) data is parsed to identify and categorize age-range appropriate programming content and organize the identified content into kids recommended categories of programming content. In this implementation, information corresponding to the EPG data is organized into at least one custom category based on age specific criteria to generate a kids-recommended program guide (KRPG). The information organized in the category(s) includes corresponding program data descriptions. The program data descriptions are linked to source content data feeds and/or corresponding information in the EPG. The KRPG is in a data format for distribution to any number of client devices to facilitate selection of age-range appropriate program data.

### TECHNICAL FIELD

This invention relates to television entertainment architectures in which program data is generated, processed, and distributed to clients such as set-top boxes, digital video recorders (DVRs), and so on.

### BACKGROUND

Electronic program guides (EPGs) enable TV viewers to navigate through an onscreen program guide and locate shows. With the guides, viewers can look at schedules of current and future programming, set reminders for upcoming programs, or enter instructions to record one or more shows.

Decisions to determine shows that children or teenagers should watch or record are often strongly influenced by a parent's perceived appropriateness of a show for viewers of a particular age. Parents that are concerned about what their children watch and/or record typically cannot easily determine the age range appropriateness of a show solely by using a conventional onscreen program guide.

For instance, conventional onscreen program guides typically only allow TV viewers to locate program content by subject, actor, release date, and subject matter (e.g., weather, sports, movies, etc.), and the like. To obtain any rating information, the user must first typically locate a show of interest from within numerous other program offerings of mixed viewer age range appropriateness. Once a show of interest has been identified, the user must then request additional information to view the program's rating. This process is slow and tedious, and does not provide a simple way for parents to monitor the shows that they would like for their children to watch.

“TV Parental Guidelines,” was established by the National Association of Broadcasters, the National Cable Television Association and the Motion Picture Association of America. These ratings are displayed on a television screen for the first 15 seconds of rated programming and, in conjunction with the V-Chip, permit parents to block programming with a certain rating from coming into their home. Yet, blocking programming with a certain rating from coming into a home is a substantially cumbersome solution for parents that have their own program viewing tastes as well as children, possibly of various age ranges, across which the appropriateness of particular shows may be different. Yet, unless parents block programming with a certain rating(s) from coming into their home, they must watch the first 15 seconds of each rated programming show to determine its age-appropriateness. Such continued vigilance in front of a television screen is just not realistic.

Accordingly, what is needed is a way for parents to determine age-appropriateness of programming content without being required to: (a) navigate through possibly hundreds of shows using an onscreen program guide and individually request ratings information for those shows that may be of interest; (b) block programming with a certain rating(s) from coming into their home; and (c) watch the first 15 seconds of each rated programming show to determine its age-appropriateness.

The following arrangements and procedures address these and other limitations of conventional techniques to present certain types of television program content to specific audiences for watching and/or recording.

### SUMMARY

Electronic program guide (EPG) data is parsed to identify and categorize age-range appropriate programming content and organize the identified content into kids recommended categories of programming content. In this implementation, information corresponding to the EPG data is organized into at least one custom category based on age specific criteria to generate a kids-recommended program guide (KRPG). The information organized in the category(s) includes corresponding program data descriptions. The program data descriptions are linked to source content data feeds and/or corresponding information in the EPG. The KRPG is in a data format for distribution to any number of client devices to facilitate selection of age-appropriate program data.

### BRIEF DESCRIPTION OF THE DRAWINGS

FIG. 1 shows exemplary kids-recommended program guide (KRPG) user interface for subsequent display in an onscreen program guide by TV viewers.

FIG. 2 shows a television entertainment system 200 that facilitates distribution of program data from a publisher to the viewers.

FIG. 3 shows an exemplary implementation of the head end server of FIG. 2.

FIG. 4 shows an exemplary kids-recommended program guide (KRPG) content authoring tool for a publisher/editorial staff to generate and manage the KRPG.

FIG. 5 shows an exemplary client implemented as a set-top box.

FIG. 6 shows an exemplary procedure to generate a kids-recommended program guide for display to viewers in a television entertainment system.

### DETAILED DESCRIPTION

### Overview

The following discussion is directed to generating recommended categories of individual episodes of child-appropriate (e.g., age-range targeted) program data. Such recommended categories include, for example, one or more age specific categories, educational, movie, holiday, popular series, and/or other categories. The recommended categories and specific episodes of programming content that comprise each recommended category are selected by an editorial staff based on any of a number of different criteria, such as by the amount of viewer traffic to certain types of program data.

A customized publishing tool distributes the custom category and program data selections as a kids-recommended program guide (KRPG) data for subsequent display in an onscreen program guide available in television entertainment systems (e.g., interactive TV networks, cable networks that utilize EPGs, and Web-enabled TV networks). The publishing tool periodically refreshes the KRPG data and continually removes program data in the KRPG data that has already aired. The onscreen program guide allows TV viewers to navigate through the KRPG data and easily locate age-appropriate shows for their children to watch and/or record.

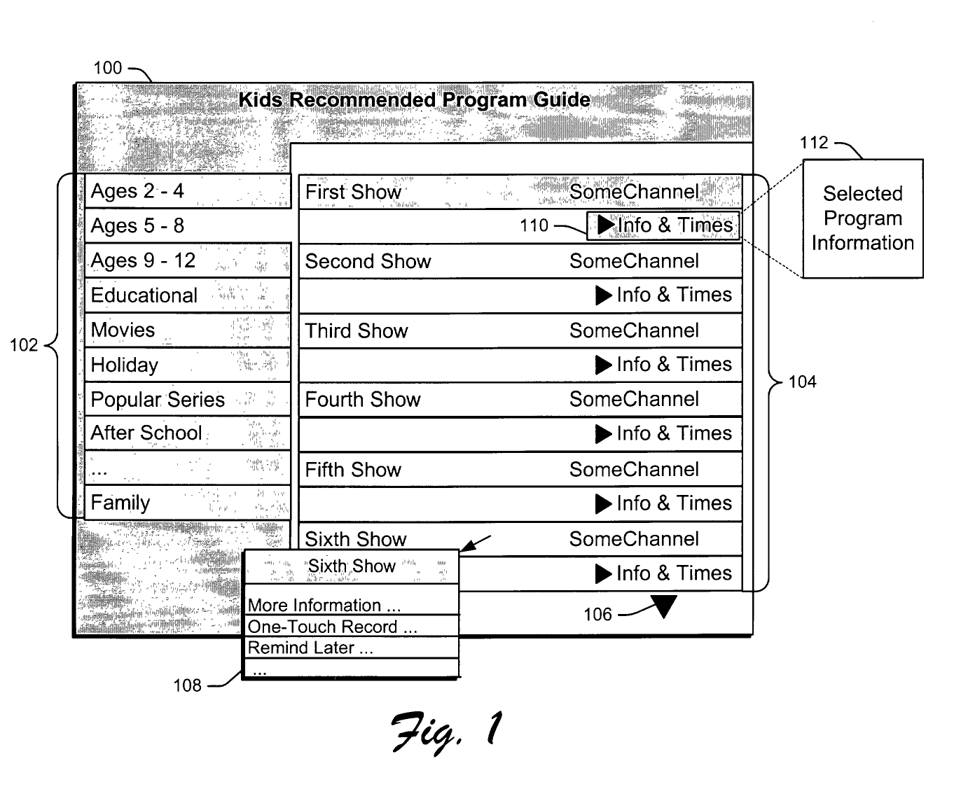

FIG. 1 shows exemplary kids-recommended program guide (KRPG) user interface (UI) 100 that may be displayed in an onscreen program guide. The KRPG UI 100 includes one or more custom program categories as indicated by the custom categories listed in column 102. In this example, the categories 102 include age group (i.e., 2-4, 5-8, and 9-12), educational, movies, holiday, popular series, after school specials, family, and others such as music, sports, and so on. The specific categories 102 that are presented in the KRPG UI 100 are completely customizable and may represent, for example, the categories that a particular producer selects to have displayed at that time.

Corresponding to each category is a sorted schedule of kids recommended programs as illustrated by the program items in column 104. In this example, the kids recommended programs for kids ages 5-8 are represented as the “First Show” through the “Sixth Show”. Each program is displayed in association with the channel over which it is broadcast (e.g., “SomeChannel”). In one implementation, only information corresponding to shows/program data that air over channels that can be received at a particular client device (e.g., a set-top box, DVR, etc.) are displayed in the UI 100. Alternatively, information corresponding to shows/program data that air over channels that can not be received at a particular client device (e.g., a set-top box, DVR, etc.) is grayed-out and unresponsive to viewer selection in the UI 100.

The number of shows represented in column 104 is a function of the number of shows that a particular producer (e.g., editorial staff) desires to represent within the particular category. The scroll window control 106 allows a viewer to scroll down through any additional kids recommended programs that may be in the list 104.

In one implementation, the top N children shows (e.g., 5-7 shows) recommended within each age category 102 bucket (e.g., ages 2-4, 5-8, and 9-12) are displayed in column 104 on a weekly basis, refreshed twice a week, and automatically expired from the category once they have aired. The top N recommended shows within rotating categories such as holiday, popular series, family, after-school specials, music, sports, and so on, are presented based on what a producer/editorial staff chooses for that time period (e.g., a week).

Popup menu 108 is displayed responsive to viewer selection of a particular show. The popup menu 108 allows the viewer to: (a) retrieve corresponding program information including, for example, the times the selected show airs; (b) record the selected program onto a video recorder (e.g., a DVR); and/or (c) set a reminder to be reminded of the selected program before the program airs. In one implementation, each particular program is associated with a corresponding “Info & Times” button control that is responsive to viewer selection to provide further descriptive information such as the air times and duration of the selected show, actors, ratings, and so on. For instance, responsive to viewer selection of “Info & Times” button control 110, popup window 112 is displayed to provide further descriptive information such as the air times and duration of the selected “First Show”, actors, ratings, and so on.

At least a subset of the elements of UI 100 are mapped to one or more Universal Resource Identifiers (URIs) that reference actual program data source content (i.e., a data feed maintained by a publisher 102 of FIG. 1) and/or further descriptive information as indicated by the EPG data 114. This mapped information is responsive to user selection to tune a client device such as a set-top box to a particular channel (i.e., data feed) over which a program is to air and/or to facilitate viewer identification of program data they are interested in watching and/or recording.

Client devices that receive and present the KRPG data (via an onscreen program guide) to viewers range from full-resource clients with substantial memory and processing resources (e.g., TV-enabled personal or general purpose computers, digital TV recorders equipped with hard-disks) to low-resource clients with limited memory and/or processing resources (e.g., set-top boxes, mobile devices such as laptops, personal digital assistants (PDAs), etc.). While aspects of the systems and methods described below can be used in any of these systems and for any types of clients, for purposes of discussion they are described in the context of a low-resource environment.

### Television Entertainment System

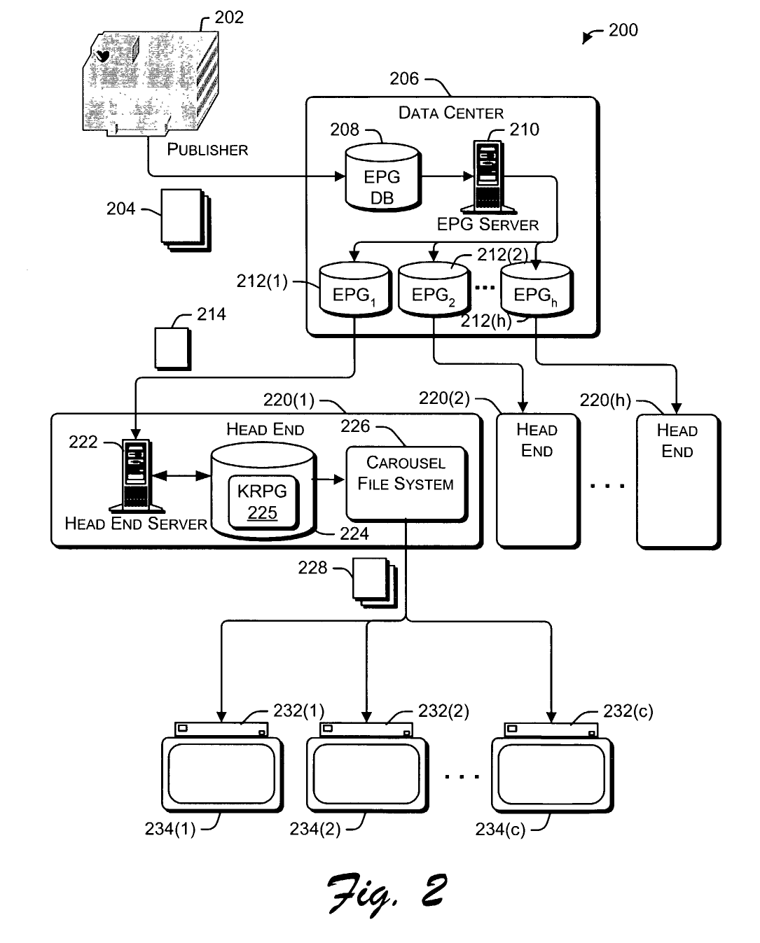

FIG. 2 shows a television entertainment system 200 that facilitates distribution of program data from a publisher to the viewers. System 200 includes a publisher 202 that creates the program data. One example of a publisher 202 is the Tribune Corporation, which generates data for interactive television networks. As used herein, program data refers to the type of data that might be used by an electronic program guide (EPG) and/or data that facilitates interactive television functionality. Program data includes program titles, guest appearances, topics, ratings, characters, other description, actor names, year made, place made, and so on. The terms “program data” and “EPG data” are used interchangeably herein.

The EPG data is transferred as one or more electronic files 204 from the publisher 202 to a data center 206. As one example, the program data 204 is transferred using a file transfer protocol (FTP) over a TCP/IP network (e.g., Internet, UNIX, etc.) to the data center 206. The electronic file 206 is stored in an EPG database 208 at the data center 206.

The original version of the EPG data contains all of the programming information for multiple days. An EPG server 210 resides at the data center 206 to process the EPG data prior to distribution. For instance, the EPG server 210 creates different versions of the program data for different head end services to account for programming preferences and lineups. The EPG server 210 limits the EPG data to those channels that are relevant to the respective head ends. In the illustrated example, the EPG server 210 creates multiple versions of the EPG data, which are designated as EPG₁, EPG₂, . . . , EPGₕ, and stores them in respective databases 212(1), 212(2), . . . , 212(h). The data center 206 transfers the head end versions of the EPG data as electronic files 214 to associated head end services 220(1), 220(2), . . . , 220(h) using, for example, FTP or other suitable transfer protocols over a network.

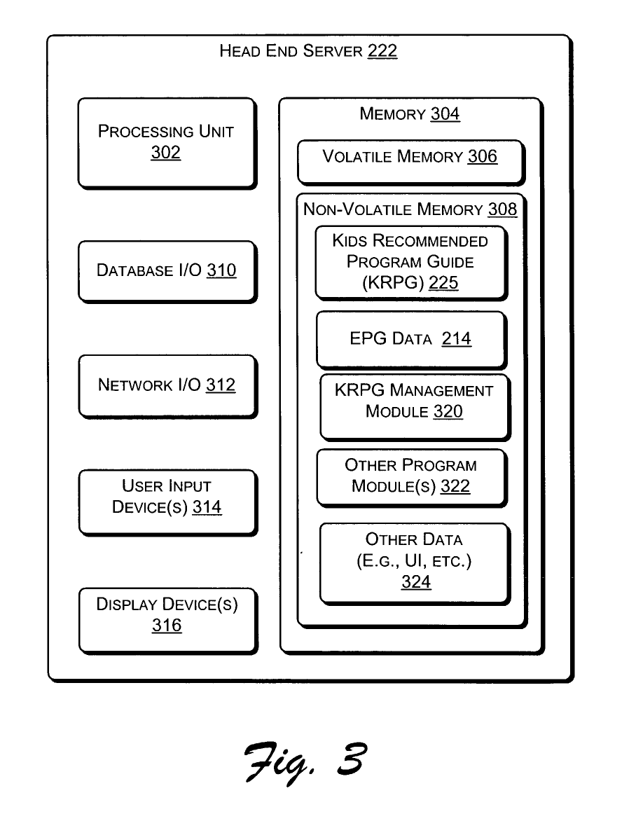

At individual head end services such as at head end service 220(1), one or more head end servers 222 store the EPG data 214 into a head end database 224. The head end server 222 parses or evaluates the EPG data prior to distribution. The parsing involves one or more techniques to identify specific episodes of EPG data for inclusion in the KRPG data 225, which is stored by the head end server 222 in the head end database 224. Such techniques are described in greater detail below in reference to FIGS. 3-6. The specific episodes of program data are arranged under custom categories that respectively indicate the age-appropriateness of the arranged program data.

For at least a portion of the information in the KRPG data 225, the head end server 222 further stores one or more corresponding URIs that respectively reference program time(s), actual source content, and so on. The URI(s) are generated from corresponding URI information provided by the EPG data 114. The URI(s) embedded into the KRPG data 225 are responsive to user selection when presented on a client device with an onscreen program guide. Responsive to such selection, a URI will tune the client device to a show, present the user with corresponding program data, and so on.

A carousel file system 226 periodically broadcasts the EPG file 214 and the KRPG data 225 as one or more electronic files 228 over an out-of-band (OOB) channel to the clients 232(1), 232(2), . . . , 232(c). The distributed file(s) 228 is/are not identical to the file 214 received from the data center 206 because it further includes the KRPG data 225. The distributed file(s) 228 may be in any of a number of different data formats such as any combination of Extensible Markup Language (XML), Hypertext Markup Language (HTML), and so on. Distribution from the head end 220 to the clients 232 may be accommodated in a number of ways, including cable, RF, microwave, network (e.g., Internet), and satellite.

In the illustrated implementation, the clients 232 are embodied as set-top boxes (STBs) connected to associated televisions 234(1), 232(2), . . . 234(c). The clients 232 are often equipped with sufficient processing and storage capabilities to store and run an operating system and a few programs. Examples of programs stored on a client might include a Web browser, an electronic programming guide (EPG), a personal scheduler, a digital video recording (DVR) programs, and so forth. Although the STBs are shown separately from the television sets, they may alternatively be built into the television sets as integral units. Furthermore, in other implementations, the clients may be embodied as other devices capable of handling EPG 214 and KRPG data 225 data (i.e., electronic file(s) 228), such as a broadcast-enabled computer, an information appliance, or the like.

### An Exemplary Head End Server

FIG. 3 shows an exemplary implementation of the head end server 222 of FIG. 2. The head end server 222 has a processing unit 302 and memory 304. Memory 304 includes volatile memory 306 (e.g., RAM) and non-volatile memory 308 (e.g., ROM, flash, floppy disk, hard disk, CD-ROM, disk array, etc.). The server 222 may be further equipped with a database I/O 310 to interface with the head end database 224 and a network I/O 312 to provide access to one or more networks. The server 222 is equipped with one or more input devices 314 (e.g., keyboard, mouse, track ball, touch panel screen, voice recognition, etc.) and one or more display devices 316.

One or more programs are stored in memory 304 and executed on processing unit 302. Such programs include KRPG module 320 and other program modules 322 such as an operating system (not shown) to provide a runtime environment. The KRPG module 320 provides a number of KRPG content authoring tools to facilitate program editor/editorial staff generation of the KRPG 225. More particularly, such tools facilitate parsing and/or evaluation of the EPG data 214 to identify specific episodes programming content for which corresponding EPG data is to be include in the KRPG 225. The EPG information corresponding to the identified episodes of program data are arranged under custom categories that respectively indicate the age-appropriateness of the identified episodes.

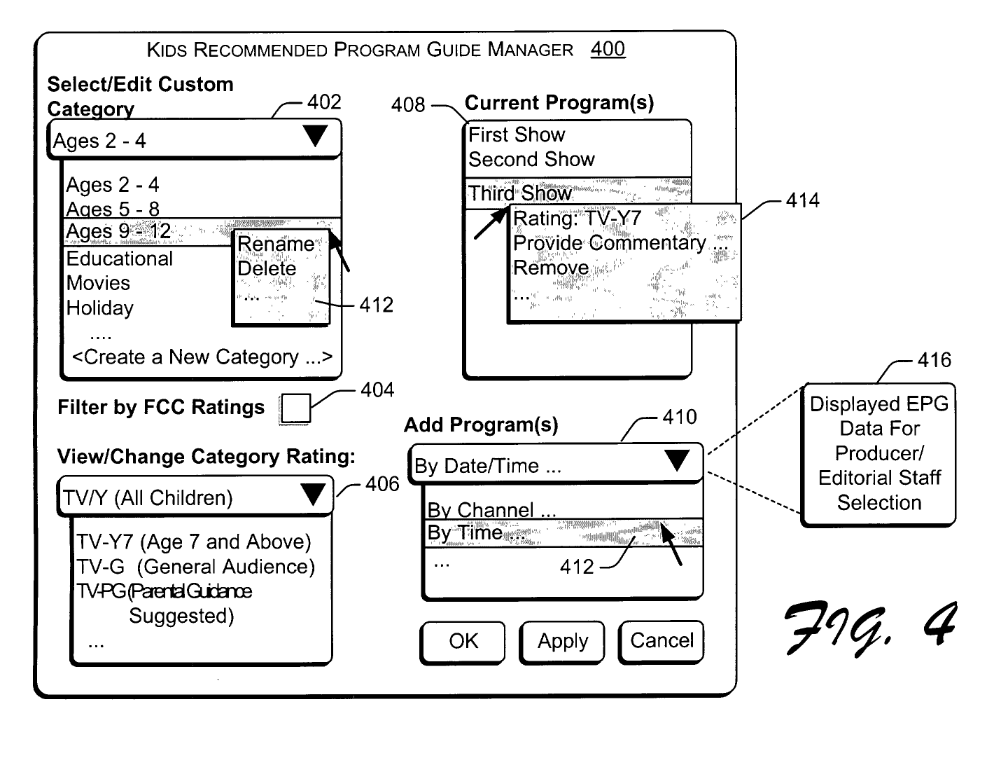

FIG. 4 shows an exemplary user interface (UI) 400 KRPG content authoring tool for a publisher/editorial staff to generate and manage the KRPG data 225. More particularly, UI 400 provides for generating and managing custom categories, assigning ratings information to custom categories, and adding particular programs to particular ones of the custom categories. The UI 400 is stored in memory 304 of FIG. 3 as at least a portion of other data 324 and is presented by the KRPG module 320. In one implementation, the UI 400 is a Web page that is served by the KRPG module 320 and presented by a Web browser application that may or may not be hosted by the head end server 222 of FIGS. 2 and 3.

The UI 400 includes a Select/Edit Custom Category drop down menu 402, a Filter by FCC Ratings checkbox 404, a View/Change Category Rating dropdown menu 406, a Current Program(s) window 406, an Add Program(s) drop down menu 408, and an EPG data display window 416. The Select/Edit Custom Category menu 402 allows a producer/editorial staff to select, rename, and remove one or more already generated custom categories from the KRPG data file 225. For instance, in this example, the “Ages 9-12” category is highlighted to indicate user selection. Popup menu 412 (displayed, for example, responsive to user selection of a right mouse button) allows the user to rename or remove the selected category from the category list 402. To create a new category, the user selects the “<Create a New Category . . . >” item located, for instance, at the bottom of menu 402, whereupon the user is prompted to input a new custom category name in a text input field of a dialog box (not shown).

The Filter by FCC Ratings checkbox 404 is selectable (On/Off) to specify whether a selected category (menu 402) is to be associated with a particular FCC TV Parental Guidelines rating. Such ratings include, for example:
TV-Y (All Children—This program is designed to be appropriate for all children.).
TV-Y7 (Directed to Older Children—This program is designed for children age 7 and above).
TV-G (General Audience—Most parents would find this program suitable for all ages).
TV-PG (Parental Guidance Suggested).
TV-14 (Parents Strongly Cautioned—This program contains some material that many parents would find unsuitable for children under 14 years of age).
TV-MA (Mature Audience Only—This program is specifically designed to be viewed by adults and therefore may be unsuitable for children under 17).
   Responsive to checking the checkbox 404, the previously grayed-out View/Change Category Rating menu 406 is activated for rating selection.

The Current Program(s) window 408 displays all program data that is currently assigned to the selected category (i.e., see menu 402). In one implementation, if the “Filter by FCC Rating” checkbox 404 is not selected, all selected category programs are displayed in window 408; otherwise, only those category programs that meet the selected rating (menu 406) are displayed in the window 408, or programs that do not meet the selected FCC rating are highlighted to indicate non-conformity with respect to the indicated rating.

In this example, window 408 shows that “The Third Show” program has been highlighted or selected. Popup menu 414, when displayed (e.g., by right clicking a mouse button on a selected program), allows the user to identify the rating of the program, and to provide custom commentary with respect to the show. Popup menu 414 further allows a user to remove the selected filter from the window 408 and from the corresponding KRPG data 225.

The Add Program(s) drop down menu 410 is used to add a program from the EPG data 214 to the selected category (i.e., as indicated by menu 402). Selected EPG data programs are added to the current programs window 408. EPG data 214 can be viewed in just about any conventional manner such as by date, time, or channel and/or combinations of these. The window 416, which is responsive to user selection of elements therein displayed, displays portions of the EPG data for user selection.

The particular portions of EPG data 214 that is displayed in the window 416 depends on criteria set in the View/Change Category Rating menu 406 (if activated) and/or according to the criteria indicated via the Add Program(s) menu 410. For instance, if a TV/Y rating has been selected for a particular category, only that EPG data 214 that conforms to that rating is displayed for selection. As respective pieces of program data specified by the EPG data 214 are selected by the user, a program is added to the program data filter(s) window 408.

Responsive to user selection of the “Apply” or “OK” controls, the KRPG data 225 is generated, updated, and/or otherwise modified based on the information specified via the KRPG manager UI 400. Although FIG. 4 is described as being used to generate and manage the KRPG data 225, such generation and maintenance can be accomplished in any of a number of different manners such as via a word processor, or an XML editor.

The KRPG data 225 is maintained in a file structure. TABLE 1 shows an exemplary KRPG data file structure.

TABLE 3
AN EXEMPLARY KIDS-RECOMMENDED PROGRAM GUIDE
DATA STRUCTURE

```
<KidsRecommendedProgramGuide>
  <CustomCategories>
    <Category name=“Ages 9-12”>
      <Rating>TV-Y</Rating>
      <Contents>
        <Content name=“First Show  2:30 PM  SomeNetwork”>
          <ProgramTuning>transportStreamURI</ProgramTuning>
          <CustomInfo>...</CustomInfo>
          <StartTime>...</StartTime>
          <Duration>...</Duration>
          <EPGprogramDesc>transportStreamURI
          </EPGprogramDesc>
        </Content>
        ...
      <Contents>
    </Category>
    <Category name=“Educatonal”>
      ...
    </Category>
    ...
  </CustomCategories>
</ KidsRecommendedProgramGuide>
```

The information of TABLE 1 is organized with respect to customized tags in a data format such as Extended Markup Language (XML). For instance, the <KidsRecommendedProgramGuide> and </KidsRecommendedProgramGuide> tags encapsulate all KRPG data 225. All custom categories are defined between <CustomCategories> and </CustomCategories> tags. Each category begins and is identified with a <Category name=“. . . ”> tag and ends with a corresponding </Category> tag. Each category includes a <Rating> . . . </Rating> tag pair to identify the maximum particular rating of the category. In this example, the maximum rating for the “Ages 9-12” category is “TV-G”. It is a “maximum” rating because although it includes narrower program content ratings such as TY-Y and TY-7, it does not include content of more broad rating standards such as TY-14.

All program data for a particular category is identified between corresponding <Contents> and </Contents> tags. Each specific item of program data begins and is identified with the <Content name=“. . . ”> tag and ends with a corresponding </Content> tag. Each identified instance of program data includes further corresponding information such as start time (i.e., the <StartTime> . . . </StartTime> tag pair), program length or duration of the program (i.e., the <Duration> . . . </Duration> tag pair), and/or other information such as custom commentary (e.g., the <CustomInfo> . . . </CustomInfo> tag pair).

Each identified instance of program data further includes one or more resource referencing mechanisms to access additional information corresponding to the program content. For instance, the <ProgramTuning> . . . </ProgramTuning> tag pair includes a “transportStreamURI” parameter, which is a URI. In this particular example, the transportStreamURI parameter references the actual source content, which may be hosted by a server (e.g., a Web server, a broadcast server, etc), an in-band or out-of-band carousel (e.g., the carousel 326 of FIG. 3), and so on. The actual source content may be accessed (via the URI) across the Internet, a digital broadcast network (cable, terrestrial, satellite), and/or the like, depending on where it is deployed.

In one implementation, the specified program is associated with a URI that references data that is deployed in the EPG data file 214. For example, the <EPGprogramDesc> . . . </EPGprogramDesc> tag pair includes a “transportStreamURI” that references additional program description, as indicated by the EPG data 214.

### An Exemplary Client

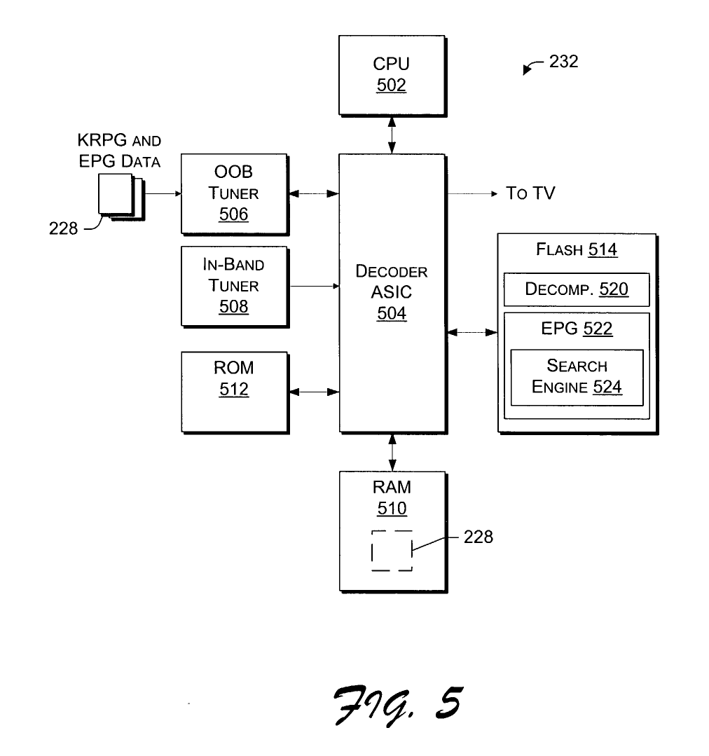

FIG. 5 shows an exemplary client 232 implemented as a set-top box. The client 232 has a central processing unit (CPU) 502 coupled to a decoder ASIC (application specific integrated circuit) 504. In addition to decoder circuitry, ASIC 504 may also contain logic circuitry, bussing circuitry, and a video controller. The client 232 further includes an out-of-band (OOB) tuner 506 to tune to the broadcast channel over which the EPG data 214 and the KRPG data 225 are downloaded as one or more electronic files 228. One or more in-band tuners 508 are also provided to tune to various television signals. These signals are passed through the ASIC 504 for audio and video decoding and then to an output to a television set or video recorder. With the tuners and ASIC 504, the client is equipped with hardware and/or software to receive and decode a broadcast video signal, such as an NTSC, PAL, SECAM or other TV system video signal and provide video data to the television set.

One or more memories are coupled to ASIC 504 to store software and data used to operate the client. In the illustrated implementation, the client has random access memory (RAM) 510, read only memory (ROM) 512, and flash memory 514. RAM 510 stores data used by the client, including the KRPG and EPG data file 228, as well as any compression table used to decompress the file. ROM 512 stores an operating system (not shown).

One or more programs may be stored in the ROM 512 or in the flash memory 514. In the illustrated example, the flash memory 514 stores a decompression program 520 that can be executed to decompress the KRPG and EPG data file 228. An EPG program 522 is also stored in the flash memory 514 to present the KRPG and EPG data for user viewing and interaction. The EPG program 522 may include a search engine 524 to search the EPG and/or KRPG data file in response to queries submitted by the viewer. The search engine might be used, for example, to locate particular television shows, custom categories, shows with a particular rating, title, or identify programs with selected actors. The EPG program 522 may automatically remove program data that has expired or already aired from the KRPG and EPG data 228.

The client 232 may further include other components, which are not shown for simplicity purposes. For instance, the client is typically equipped with hardware and/or software to present a graphical user interface (e.g., UI 100 described above in reference to FIG. 1) to a viewer, by which the viewer can navigate KRPG and EPG data file 228 and (if enabled) to access various Internet system network services, browse the Web, or send email. Other possible components might include a network connection (e.g., modem, ISDN modem, etc.) to provide connection to a network, an IR interface, display, power resources, etc. A remote control may also be provided to allow the user to control the client.

### An Exemplary Procedure to Generate a Kids-Recommended Program Guide

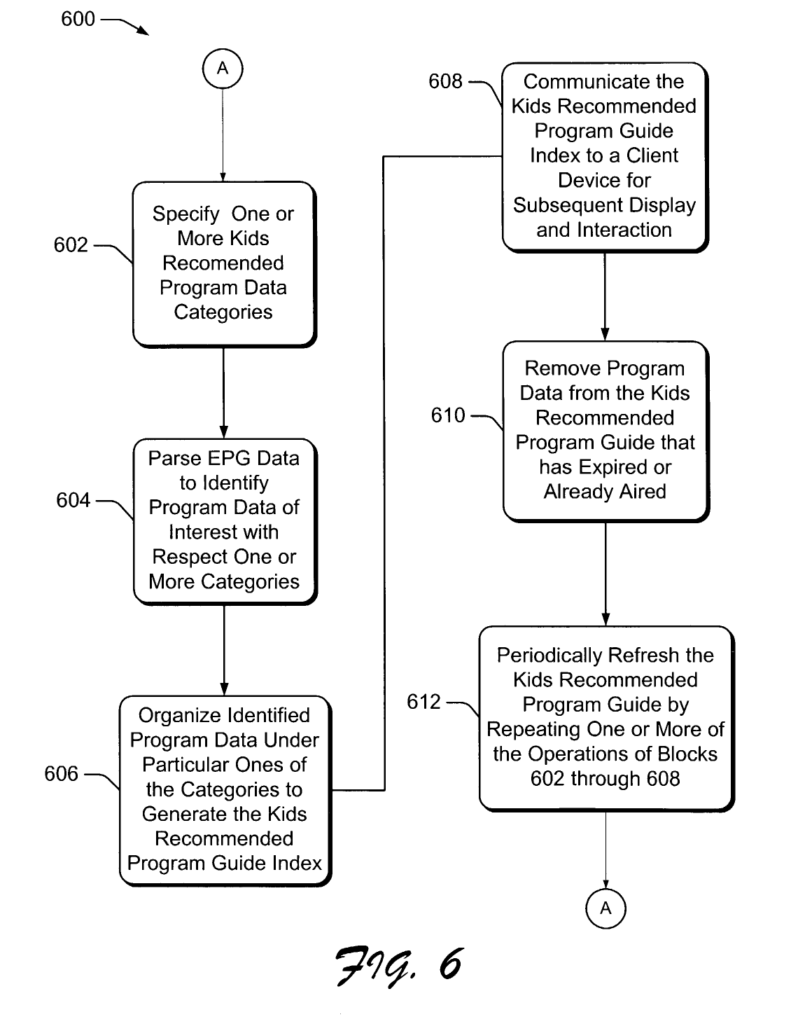

FIG. 6 shows an exemplary procedure 600 to enable specification of a kids-recommended program guide for display to viewers in a television entertainment system. The procedure may be implemented, for example, at server 222 located at the head end to develop KRPG data prior to delivery to the client. In other implementations, the procedure may be implemented at EPG server 210 or at client device 232 to develop KRPG data 225. Blocks 602, 604, and 608 represent operations that are performed by a human being that is interfacing with a user interface (e.g., UI 400 of FIG. 4) represented by computer-executable instructions that are executable by a processor. Blocks 608, 610, and 612 are performed automatically by a computing device.

At block 602, one or more custom kids recommended categories (e.g., one or more age specific categories, educational, movie, holiday, popular series, and/or other categories) are specified. In one implementation this is accomplished by editorial staff selection and/or generation of a custom kids recommended category from the drop down menu 402 of UI 400.

At block 604, EPG data is parsed or otherwise evaluated to identify program data of interest for one or more of the specified custom categories. To accomplish this, as discussed above with respect to FIG. 4, editorial staff provide input and/or otherwise select information provided by any combination of the following controls of the UI 400: (a) the View/Change Category Rating control 406; (b) the Current Program(s) control 408, and/or the Add Program(s) control 410.

At block 606, identified program data of interest (block 604) is organized under particular ones of the custom categories, thereby generating a kids-recommended program guide (i.e., KRPG 224 of FIGS. 2, 3, and 5). In particular, the editorial staff, after performing the operations of blocks 602 and 604 to select specific program content with respect to one or more selected kids recommended categories, selects the apply button of FIG. 4 to apply current UI 400 selections and continue editing the KRPG 225), or selects the ok button control of UI 400 to apply current UI 400 selections and exit the UI 400.

At block 608, the server 222 communicates the generated KRPG to a client device such as a set-top box 132 of FIG. 1 for subsequent display in a user interface (e.g., UI 100 of FIG. 1) that is responsive to viewer interaction. At block 610, program data that has expired or already aired from the KRPG is expired or removed from the KRPG. This operation is performed automatically at the client device by the EPG program 522 of FIG. 5. At block 612, the KRPG data 225 residing at the client device is periodically refreshed by the editorial staff at the server 222 by repeating at least a portion of the operations of blocks 602 through 608.

### CONCLUSION

Although the invention has been described in language specific to structural features and/or methodological acts, it is to be understood that the invention defined in the appended claims is not necessarily limited to the specific features or acts described.

For instance, although the processes of generating and managing the KRPG data 225 of FIGS. 2, 3 and 5 are described as being implemented in software executed at the head end server 222, in alternative implementations, some or all of these processes may be implemented in firmware and/or hardware. Moreover, although the exemplary procedures of the KRPG module 320 to generate the KRPG 225 for display at a client device 232 are described as having been performed by the head end server 222, these operations may alternatively be performed at the EPG server 210 or at the client device 232.

Accordingly, the specific features and acts of the detailed description are disclosed as exemplary forms of implementing the claimed invention.

1. A computer-implemented method that is implemented via stored and executable computer program instructions, the method comprising:
receiving program data for an electronic program guide (EPG); and
organizing information from at least a subset of the program data into at least two custom categories based on age specific criteria to generate a kids-recommended program guide (KRPG), the KRPG providing program data descriptions for multiple programs that are appropriate for kids, wherein said organizing comprises presenting a user interface that displays said at least two custom categories, wherein said at least two custom categories are selectable, and wherein said user interface is configured to display a sorted schedule of kids recommended programs corresponding to a selected one of said at least two custom categories, wherein said presenting is performed by an application hosted by a server,
wherein said organizing is performed by an entity other than an end user, wherein said entity comprises a publisher/editorial staff, wherein once generated, the KRPG is delivered from a server to one or more client devices for recommending episodes of program content based on one or more potential viewing audience age ranges,
wherein the KRPG is in a data format for distribution to a plurality of client devices to facilitate selection of age-appropriate program data, the data format being selected from an Extensible Markup Language (XML) or Hypertext Markup Language (HTML) data format.

2. The method of claim 1, wherein at least a portion of the program data descriptions are linked to one or more source content data feeds or corresponding information in the EPG.

3. (canceled)

4. The method of claim 1, wherein the age-specific criteria is based on ratings information embedded in the program data.

5. The method of claim 1, wherein the age-specific criteria is based on producer and/or editorial staff age-appropriate program data selections.

6. The method of claim 1, wherein at least one of the at least two custom categories comprises any combination of age specific categories, holiday, popular series, family, after-school specials, music, and/or sports categories.

7. The method of claim 1, further comprising communicating the KRPG to one or more client devices for display and user interaction.

8. The method of claim 1, further comprising:
updating the KRPG at periodic time intervals to reflect a next schedule of age-appropriate program data; and
communicating refreshed KRPG data to one or more client devices to facilitate selection of age-appropriate programming for children.

9. A computer-readable medium comprising computer-program instructions for recommending episodes of program content based on one or more potential viewing audience age-ranges, the computer-program instructions being executable by a processor to perform a method as recited in claim 1.

10. A computing device for recommending episodes of program content based on one or more potential viewing audience age-ranges, the computing device comprising a processor coupled to a memory, the memory comprising computer-program instructions executable by the processor, the computer-program instructions for performing multiple operations of a method as recited in claim 1.

11. A computer-readable medium comprising computer-program instructions executable by a processor, the computer-program instructions comprising instructions for:
specifying two or more kids recommended categories;
parsing, based on age-specific criteria, an electronic program guide (EPG) to identify program data of interest;
organizing the program data with respect to particular ones of the two or more kids recommended categories to generate a kids-recommended program guide (KRPG), the KRPG providing program data descriptions for multiple programs that are appropriate for kid, wherein said organizing comprises presenting a user interface that displays said two or more kids recommended categories, wherein said two or more kids recommended categories are selectable, and wherein said user interface is configured to display a sorted schedule of kids recommended programs corresponding to a selected one of said two or more kids recommended categories, wherein said presenting is performed by an application hosted by a server, wherein said organizing is performed by an entity other than an end user, wherein said entity comprises a publisher/editorial staff; and
communicating, from a server, the KRPG to one or more client devices to facilitate selection of age-appropriate programming, wherein the KRPG is in a data format for distribution to a plurality of client devices to facilitate selection of age-appropriate program data, the data format being selected from an Extensible Markup Language (XML) or Hypertext Markup Language (HTML) data format.

12. The computer-readable medium of claim 11, wherein the age-specific criteria is based on ratings information embedded in the program data.

13. The computer-readable medium of claim 11, wherein the age-specific criteria is based on producer and/or editorial staff program data selections.

14. The computer-readable medium of claim 11, wherein the two or more kids recommended categories comprise any combination of age specific categories, holiday, popular series, family, after-school specials, music, and/or sports categories.

15. The computer-readable medium of claim 11, further comprising computer-executable instructions for updating the KRPG at periodic time intervals to reflect current age-appropriate program data.

16. The computer-readable medium of claim 11, wherein at least a portion of the program data is linked to one or more source content data feeds and/or corresponding information in the EPG.

17. The computer-readable medium of claim 16, wherein a data feed from the one or more source content data feeds is associated with a digital broadcast stream or a Web site.

18. In a television entertainment system, a computing device comprising the processor and computer-readable medium of claim 11.

19. The computing device of claim 18, wherein the computing device comprises one of a head end server, an EPG server, a general purpose computer, a digital television recorder, or a set-top box.

20. A computer-implemented method for generating a kids-recommended program guide (KRPG), the method comprising performing operations of the computer-program instructions of claim 11.

21. A computing device comprising:
a processor;
a memory coupled to the processor, the memory comprising computer-program instructions executable by the processor, the computer-program instructions for:
evaluating, based on age-specific criteria, at least a portion of electronic programming guide (EPG) data to determine two or more kids recommended viewing categories;
generating one or more descriptions of program data corresponding to programming indicated by the EPG data;
linking portions of the one or more descriptions via one or more respective resource references to corresponding data feeds and/or content in the EPG data; and
organizing the one or more descriptions under respective ones of the two or more kids recommended viewing categories to generate a kids recommended program guide (KRPG), the KRPG providing program data descriptions for multiple programs that are appropriate for kids, the KRPG being in a data format for presentation of viewers to facilitate selection of age-appropriate program data for select audiences, the data format being selected from an Extensible Markup Language (XML) or Hypertext Markup Language (HTML) data format, wherein said organizing comprises presenting a user interface that displays said two or more kids recommended viewing categories, wherein said two or more kids recommended viewing categories are selectable, and wherein said user interface is configured to display a sorted schedule of kids recommended programs corresponding to a selected one of said two or more kids recommended viewing categories, wherein said presenting is performed by an application hosted by said computing device, wherein said organizing is performed by an entity other than an end user, wherein said entity comprises a publisher/editorial staff, wherein once generated, the KRPG is delivered by the computing device to one or more client devices for recommending episodes of program content based on one or more potential viewing audience age ranges.

22. The computing device of claim 21, wherein the computing device comprises a head end server, an EPG server, a general purpose computer, or a set-top box.

23. The computing device of claim 21, wherein the two or more kids recommended viewing categories comprises any combination of age specific categories, holiday, popular series, family, after-school specials, music, and/or sports categories.

24. The computing device of claim 21, further comprising computer-executable instructions for updating the KRPG at periodic time intervals to reflect current age-appropriate programming.

25. The computing device of claim 21, wherein the computer-program instructions further comprise instructions for communicating the KRPG to a client device for presentation of a corresponding user interface (UI).

26. (canceled)

27. The computing device of claim 21, wherein the computing device is a head end server or an EPG server, and wherein the computer-program instructions further comprise instructions for communicating the KRPG to a set-top box for presentation of a corresponding user interface (UI).

28. The computing device of claim 27, wherein the set-top box is coupled to a digital video recorder (DVR), and wherein the KRPG provides, responsive to viewer selection of an element of the UI, for recording program data by the DVR, the program data corresponding to the element.

29. A computer-readable medium comprising computer-program instructions executable by a processor, the computer-program instructions comprising instructions for:
displaying a first area of a kids recommended program guide user interface (KRPG UI) to present two or more kids recommended viewing categories, each kids recommended viewing category representing a specific age range programming content; and
presenting a second area of the KRPG UI to display program data corresponding to the two or more kids recommended viewing categories, the program data being linked to source content via one or more respective data feeds and/or being linked to descriptions in a different electronic programming guide (EPG) that does not organize program data by age-appropriate programming categories,
wherein an associated kids recommended program guide (KRPG) was previously received from a server and was defined by an entity other than an end user, the KRPG providing program data descriptions for multiple programs that are appropriate for kids, wherein said entity comprises a publisher/editorial staff, wherein the KRPG is in a data format for distribution to a plurality of client devices to facilitate selection of age-appropriate program data, the data format being selected from an Extensible Markup Language (XML) or Hypertext Markup Language (HTML) data format.

30. The computer-readable medium of claim 29, wherein the user interface further comprises a third area to provide a viewer with additional information with respect to selected program data.

31. The computer-readable medium of claim 29, wherein the user interface further comprises a third area to allow the viewer to perform additional functionality with respect to the selected program data.

32. The computer-readable medium of claim 31, wherein the additional functionality includes an ability to communicate information corresponding to selected program data to a recording device to record the selected program data.

33. The computer-readable medium of claim 31, wherein the additional functionality includes an ability to search the different EPG for more information associated with the selected program data.

34. A computing device comprising:
evaluation means for evaluating a at least a portion of electronic programming guide (EPG) data to determine two or more kids recommended viewing categories based on age-specific criteria; and
generation means for generating a kids-recommended program guide (KRPG) from the portion, the KRPG providing program data descriptions for multiple programs that are appropriate for kids, wherein said generation means comprises user interface means that displays said two or more kids recommended viewing categories, wherein said two or more kids recommended viewing categories are selectable, and wherein said user interface is configured to display a sorted schedule of kids recommended programs corresponding to a selected one of said two or more kids recommended viewing categories, wherein said evaluation means and said generating means reside on a server, wherein said KRPG is in a data format for distribution to one or more client devices for recommending episodes of program content based on one or more potential viewing audience age ranges, the data format being selected from an Extensible Markup Language (XML) or Hypertext Markup Language (HTML) data format, wherein said KRPG is generated based on input from a publisher/editorial staff.

35. The computing device of claim 34, wherein the computing device comprises a head end server, an EPG server, a general purpose computer, or a set-top box.

36. The computing device of claim 34, further comprising means for updating the KRPG at periodic time intervals to reflect current age-appropriate programming.

37. The computing device of claim 34, further comprising means for communicating the KRPG to a client device for presentation of a corresponding user interface (UI).

38. The computing device of claim 34, wherein the computing device further comprises linking means for linking elements of the KRPG to corresponding data feeds or content in the EPG data.

39. The computing device of claim 34, wherein the computing device further comprises organizing means for organizing elements of the KRPG under one or more custom kids recommended viewing categories.

40. A computing device comprising:
specifying means for specifying two or more kids recommended categories;
parsing means for parsing, based on age-specific criteria, electronic program guide (EPG) to identify program data of interest;
and organizing means for organizing the program data of interest with respect to the two or more kids recommended categories to generate a kids-recommended program guide (KRPG), the KRPG providing program data descriptions for multiple programs that are appropriate for kids, wherein said organizing means comprises user interface means that displays said two or more kids recommended categories, wherein said two or more kids recommended categories are selectable, and wherein said user interface is configured to display a sorted schedule of kids recommended programs corresponding to a selected one of said two or more kids recommended categories, wherein said organizing means resides on a server, wherein said KRPG is in a data format for distribution to one or more client devices for recommending episodes of program content based on one or more potential viewing audience age ranges, the data format being selected from an Extensible Markup Language (XML) or Hypertext Markup Language (HTML) data format, and wherein said organizing means performs said organizing based, at least in part, from input received from a publisher/editorial staff.

41. The computing device of claim 40, further comprising communication means for communicating the KRPG to one or more client devices to facilitate viewer selection of age-appropriate programming.
